(19) United States
(12) Patent Application Publication
(10) Pub. No.: US 2026/0331754 A1
(43) Pub. Date: Oct. 22, 2026

(54) ANTENNA AND BASE STATION

(71) Applicant: Huawei Technologies Co., Ltd., Shenzhen (CN)

(72) Inventors: Jinsong Lv, Shanghai (CN); Haizheng Tang, Shanghai (CN); Haisheng Yu, Shenzhen (CN); Hongxian Zhang, Shanghai (CN); Jinju Wang, Dongguan (CN); Wenfang Li, Dongguan (CN); Li Zhang, Dongguan (CN)

(21) Appl. No.: 19/710,717

(22) Filed: Jun. 17, 2026

Related U.S. Application Data
(63) Continuation of application No. PCT/CN2024/126677, filed on Oct. 23, 2024.

(30) Foreign Application Priority Data
Dec. 18, 2023 (CN) 202311751798.9

(51) Int. Cl. H01Q 1/24; H01Q 1/42; H01Q 15/14

(52) U.S. Cl. CPC H01Q 1/246; H01Q 1/42; H01Q 15/14

(57) ABSTRACT

This application provides an antenna and a base station. The antenna provided in this application includes a mounting structural member and at least two antenna subarrays. Each antenna subarray includes a radome, a reflector, and a radiating element. The radiating element is located on a side of the reflector and connected to the reflector, and the reflector and the radiating element are accommodated in the radome. The radome includes a radome body and two end covers. The radome body is an integral structure. Each end cover seals one end portion of the radome body, thereby protecting the reflector and the radiating element. The mounting structural member is located outside the radome of each antenna subarray, at least one of the radome or the reflector of each antenna subarray is connected to the mounting structural member, and any two adjacent antenna subarrays are spaced apart from each other.

### CROSS-REFERENCE TO RELATED APPLICATIONS

This application is a continuation of International Application No. PCT/CN 2024/126677, filed on Oct. 23, 2024, which claims priority to Chinese Patent Application No. 202311751798.9, filed on Dec. 18, 2023. The disclosures of the aforementioned applications are hereby incorporated by reference in their entireties.

### TECHNICAL FIELD

This application relates to the field of communication technologies, and in particular, to an antenna and a base station.

### BACKGROUND

With the development of mobile communication, usage of mobile terminals is increasing, and network coverage of a mobile cellular network is a key factor in mobile communication. A critical device in a mobile cellular network is an antenna. Generally, the gain aperture of an antenna is positively correlated with its physical size. In other words, to achieve higher gain, the antenna needs to have a larger size.

However, antennas are usually mounted on high places like poles or towers. A larger antenna size causes leads to increased wind resistance, which subjects the antenna to greater mechanical loads. This adversely affects the structural reliability of the antenna, and in turn, its service life. To improve antenna reliability, reinforcement designs are required for both the antenna and its mounting structure. However, this greatly increases antenna installation costs. Based on this, how to design an antenna that meets size requirements while reducing wind resistance and ensuring a reliable structure has become an urgent problem to be resolved by a person skilled in the art.

### SUMMARY

This application provides an antenna and a base station, to reduce wind resistance of the antenna, thereby improving its structural reliability.

According to a first aspect, this application provides an antenna, where the antenna includes a mounting structural member and at least two antenna subarrays, each antenna subarray includes a radome, a reflector, and a radiating element, the radiating element is located on a side of the reflector and connected to the reflector, and the reflector and the radiating element are accommodated in the radome. The radome includes a radome body and two end covers, the two end covers are respectively disposed at two end portions of the radome body, and each end cover seals one end portion of the radome body, thereby protecting structures such as the reflector and a radiation plate. In addition, the radome body of the radome is an integral structure, so that structural reliability of the antenna subarray can be effectively improved. The mounting structural member is located outside the radome of each antenna subarray, and at least one of the radome or the reflector of each antenna subarray is connected to the mounting structural member, and any two adjacent antenna subarrays are spaced apart from each other. In the antenna provided in this application, there is a ventilation gap between any two adjacent antenna subarrays. This can help reduce wind resistance of the antenna, thereby improving its structural reliability.

In a possible implementation of this application, the reflector is a continuous plate-shaped structure. This can effectively improve reflection performance of the reflector on a radio frequency signal radiated by the radiating element. Alternatively, the reflector may be of a perforated plate-shaped structure. In this way, the reflector may be adjusted to have frequency selectivity by adjusting a perforated pattern of the reflector, so that the reflector can reflect a radio frequency signal of a specific frequency and can transmit a radio frequency signal of a specific frequency, and the antenna can be stacked with another antenna, thereby implementing co-aperture mounting of antennas in different operating frequency bands. In this way, the antenna can be upgraded and expanded without changing the existing antenna, thereby reducing upgrade costs of the antenna and reducing mounting costs of the antenna.

According to a second aspect, this application further provides an antenna, where the antenna includes a mounting structural member and at least two antenna subarrays, each antenna subarray includes a radome, a reflector, and a radiating element, the radiating element is located on a side of the reflector and connected to the reflector, and the reflector and the radiating element are accommodated in the radome. The radome includes a radome body and two end covers. The two end covers are respectively disposed at two end portions of the radome body, and each end cover seals one end portion of the radome body, thereby protecting structures such as the reflector and a radiation plate. In addition, the reflector is connected to an inner sidewall of the radome, and the reflector is a perforated plate-shaped structure. The mounting structural member is located outside the radome of each antenna subarray, and at least one of the radome or the reflector of each antenna subarray is connected to the mounting structural member, and any two adjacent antenna subarrays are spaced apart from each other. In the antenna provided in this application, there is a ventilation gap between any two adjacent antenna subarrays. This can help reduce wind resistance of the antenna, thereby improving its structural reliability. In addition, because the reflector is a perforated plate-shaped structure, the reflector may be adjusted to have frequency selectivity by adjusting a perforated pattern of the reflector, so that the reflector can reflect a radio frequency signal of a specific frequency and can transmit a radio frequency signal of a specific frequency, and the antenna can be stacked with another antenna, thereby implementing co-aperture mounting of antennas in different operating frequency bands. In this way, the antenna can be upgraded and expanded without changing the existing antenna, thereby reducing upgrade costs of the antenna and reducing mounting costs of the antenna.

According to the antenna provided in the first aspect and the second aspect of this application, the reflector includes at least two sub-reflector layers, the at least two sub-reflector layers are stacked along a side away from the radiating element, and any two adjacent sub-reflector layers are spaced apart from each other. The reflector uses the foregoing design, and reflection performance of the reflector for reflecting a radio frequency signal radiated by the radiating element may be improved by using a joint design of at least two sub-reflector layers. In addition, by setting the reflector as at least two sub-reflector layers, an overall width of the reflector is further reduced, thereby facilitating a reduction in a width of the antenna subarray. In this way, a spacing between two adjacent antenna subarrays can be increased without changing an overall size of the antenna, or a size of the antenna can be reduced while performance of the antenna is ensured, thereby helping reduce wind resistance of the antenna.

It can be learned from the foregoing description that the reflector is connected to the inner sidewall of the radome. Therefore, when the reflector includes at least two sub-reflector layers, each sub-reflector layer may be connected to the inner sidewall of the radome, to improve reliability of connection between the reflector and the radome. Alternatively, at least one of the sub-reflector layers may be connected to the inner wall of the radome, and two adjacent sub-reflector layers are connected via a rigid support member. In this way, after the two adjacent sub-reflector layers are connected to the rigid support member, the at least one of the sub-reflector layers may be connected to the inner wall of the radome, thereby effectively improving assembly efficiency of the reflector and the radome.

To improve reflection performance of the reflector on a radio frequency signal radiated by the radiating element, in a possible implementation of this application, at least one of the sub-reflector layers of the reflector may include two oppositely disposed bent portions, and each bent portion is bent in a direction from the reflector toward the radiating element. The foregoing design of the sub-reflector layer of the reflector is also conducive to reducing an overall width of the reflector, and therefore is conducive to reducing a width of the antenna subarray.

In addition, each antenna subarray further includes two metal baffle plates, the two metal baffle plates are disposed opposite to each other, and the two metal baffle plates are connected to the inner wall of the radome. The radiating element is located between the two metal baffle plates, and an arrangement direction of two bent portions of each reflector layer is the same as an arrangement direction of the two metal baffle plates. In this way, the two metal baffle plates may reflect a radio frequency signal radiated by the radiating element, which helps improve front-to-rear ratio performance of the antenna subarray, and therefore improves signal radiation performance of the antenna subarray.

In a possible implementation of the first aspect and the second aspect of this application, the radiating element includes a first radiating portion and a second radiating portion that are connected, the first radiating portion and the second radiating portion form a predetermined included angle, the first radiating portion is connected to the reflector, and the second radiating portion is bent in a direction from the first radiating portion toward the reflector. In this application, the radiating element of the antenna subarray is designed in the foregoing two bending manners, so that an area occupied by the radiating element on the reflector can be effectively reduced. This helps reduce a size of the reflector, and further helps reduce a width size of the antenna subarray.

In addition, each antenna subarray further includes a band-stop reactance layer, the band-stop reactance layer is a perforated metal layer, the radiating element is located between the band-stop reactance layer and the reflector, and the band-stop reactance layer is connected to the inner sidewall of the radome. In this way, a radio frequency signal radiated by the radiating element may be radiated through a perforated portion of the band-stop reactance layer. In this way, a perforated pattern of the band-stop reactance layer may be appropriately designed, to adjust a bandwidth of the radio frequency signal radiated by the radiating element, thereby improving signal radiation performance of the antenna subarray.

In this application, to improve effect of adjusting the bandwidth of the radio frequency signal radiated by the radiating element by the band-stop reactance layer, a projection of the band-stop reactance layer onto the reflector covers a projection of the radiating element onto the reflector, thereby improving electrical performance of the antenna subarray.

In a possible implementation of the first aspect and the second aspect of this application, a cross-sectional shape of the radome body of the radome may be elliptical, circular, or rounded-rectangular, or the like. In addition, the radome body of the radome may be of a cylindrical structure that is integrally formed by using a process like extrusion molding. In this way, while structural reliability of the radome is ensured, a width size of the radome can be reduced, thereby reducing wind resistance of the antenna.

In addition, spacings between any two adjacent antenna subarrays are equal. In this way, wind resistance of the antenna can be reduced while requirements such as array performance and the like of the antenna can be met.

In this application, according to different application scenarios of the antenna, the mounting structural member may be disposed in a plurality of forms. For example, in a possible implementation of the first aspect and the second aspect, the mounting structural member is a beam structure. In addition, the antenna includes at least two mounting structural members, the at least two mounting structural members are spaced apart from each other, and at least one of the radome or the reflector of each antenna subarray is connected to each mounting structural member. In this way, the at least two antenna subarrays can be reliably connected via the at least two mounting structural members, which helps improve structural reliability of the antenna.

In another possible implementation of the first aspect and the second aspect, the mounting structural member is a bent structure. In this case, the antenna also includes at least two mounting structural members, the at least two mounting structural members are spaced apart from each other, and at least one of the radome or the reflector of each antenna subarray is connected to each mounting structural member. In this way, the at least two antenna subarrays can be reliably connected via the at least two mounting structural members, which helps improve structural reliability of the antenna.

A bent shape of the mounting structural member disposed in the bending structure mentioned above may be a U shape, a V shape, an arc shape, a triangle, or the like, and may be specifically designed based on a specific application scenario of the antenna.

In another possible implementation of the first aspect and the second aspect, the mounting structural member includes a first rotating portion and a second rotating portion, the first rotating portion is hinged to the second rotating portion, and at least one of the radome or the reflector of at least one of the at least two antenna subarrays is connected to the first rotating portion; and at least one of the radome or the reflector of at least one of the at least two antenna subarrays is connected to the second rotating portion. In this way, an overall form of the antenna may be adjusted by rotating the first rotating portion and the second rotating portion relative to each other, so that the antenna can meet requirements of different application scenarios for the form of the antenna. This helps expand an application scope of the antenna.

Specifically, when the mounting structural member is connected to the antenna subarray, in a possible implementation of the first aspect and the second aspect of this application, the mounting structural member may be integrally formed with the end covers disposed on a same side of the at least two antenna subarrays. This helps simplify the structure of the antenna and improve assembly efficiency of the antenna.

In addition to the foregoing structure, the antenna provided in this application further includes a radio frequency active module. The radio frequency active module is located outside the radome of each antenna subarray, the radio frequency active module is connected to at least one of the radome or the reflector of each antenna subarray, and the radio frequency active module is electrically connected to the radiating element of each antenna subarray. This helps improve convenience of electrical connection between the radio frequency active module and each radiating element, and can reduce a connection cable between the radio frequency active module and the radiating element, thereby helping reduce costs of the antenna.

In a possible implementation of the first aspect and the second aspect of this application, the antenna includes at least two radio frequency active modules, the at least two radio frequency active modules are located outside the radome of each antenna subarray, each radio frequency active module is connected to at least one of the radome or a reflector of the at least one antenna subarray, and each radio frequency active module is electrically connected to the radiating element of the at least one antenna subarray. In this way, flexibility of disposing the radio frequency active module and flexibility of connecting the radio frequency active module to the radiating elements of the at least two antenna subarrays can be effectively improved.

In addition, when the antenna includes at least two radio frequency active modules, the at least two radio frequency active modules may be disposed in a one-to-one correspondence with the at least two antenna subarrays, each radio frequency active module is located outside the radome of a corresponding antenna subarray, and each radio frequency active module is electrically connected to the radiating element of the corresponding antenna subarray. With such a design, flexibility of an overall form design of the antenna can be further effectively improved, so that the antenna is applicable to a wider scenario range.

According to a third aspect, this application further provides a base station, where the base station includes a support and the antenna according to the first aspect or the second aspect, and the antenna is connected to the support. Because wind resistance of the antenna of the base station is small, the antenna has high structural reliability. This helps improve reliability of the structure and signal radiation performance of the base station.

### BRIEF DESCRIPTION OF THE DRAWINGS

FIG. 1 is a diagram of a system architecture according to an embodiment of this application;

FIG. 2 is a diagram of an application scenario of an antenna according to an embodiment of this application;

FIG. 3 is a diagram of a structure of an antenna according to an embodiment of this application;

FIG. 4 is an A-A sectional view of the antenna shown in FIG. 3;

FIG. 5 is a diagram of a structure of a reflector according to an embodiment of this application;

FIG. 6 is a diagram of a structure in which an antenna and another antenna are stacked according to an embodiment of this application;

FIG. 7 is a sectional view of an antenna subarray according to this application;

FIG. 8 is another sectional view of an antenna subarray according to this application;

FIG. 9 is another sectional view of an antenna subarray according to this application;

FIG. 10 is another sectional view of an antenna subarray according to this application;

FIG. 11 is a diagram of another structure of an antenna according to an embodiment of this application;

FIG. 12a to FIG. 12e are diagrams of other structures of an antenna according to an embodiment of this application;

FIG. 13 is a diagram of another structure of an antenna according to an embodiment of this application;

FIG. 14a to FIG. 14c are diagrams of other structures of an antenna according to an embodiment of this application; and

FIG. 15a to FIG. 15c are diagrams of several application scenarios of an antenna according to an embodiment of this application.

### REFERENCE NUMERALS

1000: base station; 2000: terminal;
100: antenna; 1001: antenna subarray; 10: radome; 1: radome body; 2: end cover; 20: antenna connector; 30: radiating element;
301: first radiating portion; 302: second radiating portion; 40: reflector; 401: perforated pattern; 402a and 402b: sub-reflector layers;
4021: bent portion; 50: adjustment unit; 60: phase shifter; 70: rigid support member; 80: metal baffle plate; 90: band-stop reactance layer;
1002: mounting structural member; 10021: first rotating portion; 10022: second rotating portion; 10023: hinge shaft;
1003: radio frequency active module; 100a: another antenna; 200: support; 300: baseband processing unit;
400: connection wire; and 500: grounding apparatus.

### DETAILED DESCRIPTION OF ILLUSTRATIVE EMBODIMENTS

To make the objectives, technical solutions, and advantages of this application clearer, the following further describes this application in detail with reference to the accompanying drawings. However, example implementations may be implemented in a plurality of forms, and are not to be construed as being limited to implementations described herein. Same reference numerals in the drawings indicate same or similar structures. Therefore, repeated descriptions thereof are omitted. Expressions of positions and directions in embodiments of this application are described by using the accompanying drawings as examples. However, changes may also be made as needed, and all the changes fall within the protection scope of this application. The accompanying drawings in embodiments of this application are merely used to illustrate relative position relationships and do not represent an actual scale.

It should be noted that specific details are set forth in the following descriptions for ease of understanding this application. However, this application can be implemented in a plurality of manners different from those described herein, and a person skilled in the art can perform similar promotion without departing from the connotation of this application. Therefore, this application is not limited to the following disclosed specific implementations.

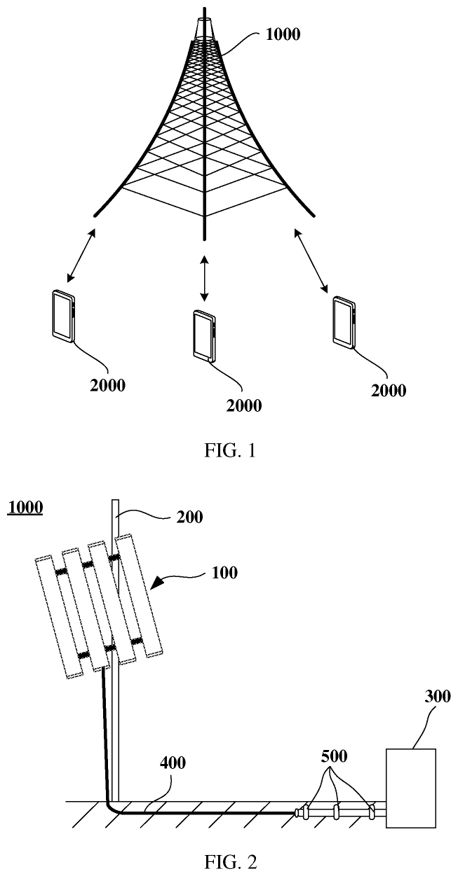

To facilitate understanding of an antenna and a base station provided in this application, the following first describes an application scenario of the antenna and the base station. FIG. 1 is an example of a diagram of a system architecture to which an embodiment of this application is applicable. As shown in FIG. 1, the system architecture may include a base station 1000 and a terminal 2000. Wireless communication can be implemented between the base station 1000 and the terminal 2000. The base station 1000 may also be referred to as an access network device, and may be located in a base station subsystem (base station subsystem, BSS), a terrestrial radio access network (UMTS terrestrial radio access network, UTRAN), or an evolved terrestrial radio access network (evolved universal terrestrial radio access network, E-UTRAN), and is configured to perform cell coverage of a signal to implement communication between a terminal device and a wireless network. Specifically, the base station 1000 may be a base transceiver station (base transceiver station, BTS) in a global system for mobile communications (global system for mobile communications, GSM) or a code division multiple access (code division multiple access, CDMA) system, may be a NodeB (NodeB, NB) in a wideband code division multiple access (wideband code division multiple access, WCDMA) system, may be an evolved NodeB (evolved NodeB, eNB or eNodeB) in a long term evolution (long term evolution, LTE) system, or may be a radio controller in a cloud radio access network (cloud radio access network, CRAN) scenario. Alternatively, the base station 1000 may be a relay station, an access point, a vehicle-mounted device, a wearable device, a gNode (gNodeB or gNB) in a new radio (new radio, NR) system, an access network device in a future evolved network, or the like. This is not limited in this embodiment of this application.

The base station 1000 is equipped with an antenna 100 to implement signal transmission in space. FIG. 2 is a diagram of an application scenario of the antenna 100 with which the base station 1000 is equipped shown in FIG. 1. FIG. 2 shows structures such as a support 200 and the antenna 100. The support 200 may be, but is not limited to, a pole, a tower, or the like. The antenna 100 is connected to the support 200 like the pole or the tower, so that the antenna 100 receives or transmits a signal. A radome 10 has a good electromagnetic wave penetration characteristic in terms of electrical performance, and can withstand impact of an external harsh environment in terms of mechanical performance, so that an antenna system can be protected from impact of the external environment.

Currently, as a gain and a diameter of an antenna increase, a structural size of the antenna also increases. In addition, with an increase in a communication rate and an increase in a communication bandwidth, the antenna usually integrates a multiple-input multiple-output (multiple input multiple output, MIMO) technology, that is, a plurality of columns of radiating elements used for signal transmission or reception are integrated into one antenna. However, the integrated design of the antenna also causes an increase in a size of the antenna. In addition, the size of the antenna is further related to an operating frequency band. A lower operating frequency band requires a larger size of a matched antenna. It can be learned from the foregoing description of the base station that an antenna is usually mounted at a high position of a support such as a pole or a tower, and a larger size of the antenna indicates greater wind resistance and more site space occupied by the antenna.

In view of this, the antenna provided in this application is divided into a plurality of antenna subarrays, and the antenna subarrays are spaced apart from each other to form an air ventilation region, so that the antenna can meet a size design requirement and effectively reduce wind resistance of the antenna. This helps improve structural reliability of the antenna and prolong a service life of the antenna. To facilitate understanding of the technical solutions of this application, the following specifically describes an antenna provided in this application with reference to the accompanying drawings and specific implementations.

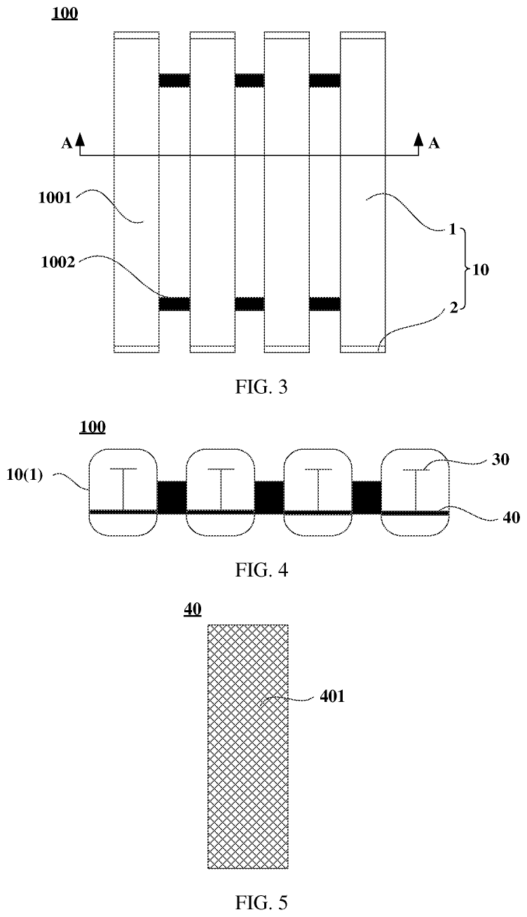

FIG. 3 is a diagram of a structure of the antenna 100 according to an embodiment of this application. The antenna 100 includes at least two antenna subarrays 1001 and a mounting structural member 1002, and the at least two antenna subarrays 1001 are connected via the mounting structural member 1002 to form an antenna array.

Each antenna subarray 1001 includes a radome 10. When the radome 10 is specifically disposed, as shown in FIG. 3, the radome 10 includes a radome body 1 and two end covers 2. The two end covers 2 are respectively disposed at two end portions of the radome body 1, and each end cover 2 seals one end portion of the radome body 1. In this way, the radome 10 forms a closed cavity, so that the radome 10 can protect components accommodated in the cavity of the radome 10 against dust and water.

FIG. 4 is an A-A sectional view of the antenna 100 shown in FIG. 3. In this embodiment of this application, the radome body 1 of the radome 10 may be of an integral structure. In other words, the radome body 1 may be prepared by using an integrated molding process like extrusion, which helps improve structural reliability of the radome 10.

In some other possible embodiments of this application, the radome body 1 of the radome 10 may alternatively be of an assembled structure. In other words, the radome body 1 may be of a structure obtained by assembling a plurality of components, to improve flexibility of disposing the radome 10.

In addition, in this application, the radome body 1 may be of a cylindrical structure, and a cross-sectional shape of the radome body 1 is not limited to a rounded rectangle shown in FIG. 5, and may alternatively be circular, elliptical, teardrop-shaped, or the like. Details are not listed herein one by one.

Still refer to FIG. 4. Each antenna subarray 1001 further includes a reflector 40 and a radiating element 30. The reflector 40 and the radiating element 30 are accommodated in the radome 10, the radiating element 30 is located on a side of the reflector 40, and the radiating element 30 is connected to the reflector 40. In addition, the reflector 40 may be connected to an inner sidewall of the radome 10, and a connection manner of the reflector 40 may be but is not limited to clamping, bonding, threaded connection, or the like, so that the reflector 40 can reliably support the radiating element 30.

In this embodiment of this application, the radiating element 30 may also be referred to as an antenna element, an element, or the like. The radiating element 30 is a unit that forms a basic structure of an antenna array, and can effectively radiate or receive an antenna signal. Frequencies of different radiating elements 30 may be the same or different. The reflector 40 may also be referred to as a baseplate, an antenna panel, a metal reflective surface, or the like. The reflector 40 may reflect and aggregate received signals on a reception point. The radiating element 30 is usually placed on a side of the reflector 40. This not only can greatly enhance a signal reception or transmission capability, but also can block and shield an interference signal from a rear surface of the reflector 40. In this application, the rear surface of the reflector 40 is a side of the reflector 40 opposite to a side on which the radiating element 30 is disposed.

In this embodiment of this application, as shown in FIG. 3 and FIG. 4, the mounting structural member 1002 is located outside the radome 10 of each antenna subarray 1001. Therefore, when each antenna subarray 1001 is connected to the mounting structural member 1002, at least one of the radome 10 or the reflector 40 of each antenna subarray 1001 may be connected to the mounting structural member 1002. During specific implementation, the radome body 1 of the radome 10 of the antenna subarray 1001 may be connected to the mounting structural member 1002 through a fastener like a bolt, or the reflector 40 of the antenna subarray 1001 may be connected to the mounting structural member 1002 through a fastener that passes through the radome 10, or both the radome 10 and the reflector 40 of the antenna may be connected to the mounting structural member 1002.

In addition, as shown in FIG. 3 and FIG. 4, in the antenna 100 provided in this application, any two adjacent antenna subarrays 1001 are spaced apart from each other. In this way, there is an air ventilation gap between any two adjacent antenna subarrays 1001, so that wind resistance of the antenna 100 can be reduced, thereby improving structural reliability of the antenna 100.

It should be noted that a spacing between two adjacent antenna subarrays 1001 is not limited in this application. For example, in a possible embodiment, spacings between any two adjacent antenna subarrays 1001 may be equal, to meet requirements of array performance such as electrical performance and physical performance of the antenna 100.

It may be understood from the foregoing description of the reflector 40 and the radiating element 30 of the antenna subarray 1001 that, in each antenna subarray 1001, to improve reflection effect of the reflector 40 on a signal radiated by the radiating element 30, an end portion of the reflector 40 may be pressed against the inner sidewall of the radome 10, so that an area of the reflector 40 is large. In addition, the reflector 40 may further be of a continuous plate-shaped structure, to improve reflection performance of the reflector 40. Both increasing the area of the reflector 40 and setting the reflector 40 to the continuous plate-shaped structure can effectively ensure front-to-rear ratio performance of the antenna subarray 1001. In this application, for ease of description, a direction from the reflector 40 toward the radiating element 30 may be defined as a front of the antenna subarray 1001, and a direction from the radiating element 30 toward the reflector 40 may be defined as a rear of the antenna subarray 1001. Based on this, it may be understood that the front-to-rear ratio performance of the antenna subarray 1001 refers to a ratio of energy radiated forward by the antenna subarray 1001 to energy radiated backward by the antenna subarray 1001. A larger ratio indicates smaller energy radiated backward by the antenna subarray 1001, and smaller impact on another antenna located behind the antenna subarray 1001.

In the antenna 100 provided in this application, in addition to being set as the foregoing continuous plate-shaped structure, the reflector 40 of the antenna subarray 1001 may be set in another possible form. For example, FIG. 5 is a diagram of a structure of the reflector 40 according to an embodiment of this application. The reflector 40 shown in FIG. 5 is a perforated plate-shaped structure. A perforated pattern 401 of the reflector 40 may be specifically set based on a wavelength of a radio frequency signal of an operating frequency band of the antenna subarray 1001. For example, the perforated pattern 401 may be a periodic and regular grid pattern, or may be an aperiodic and irregular pattern, to ensure that the antenna subarray 1001 has high front-to-rear ratio performance.

In addition, a perforated portion of the perforated pattern 401 of the reflector 40 shown in FIG. 5 may be further filled with an insulation medium. The insulation medium may be, for example, plastic. This can help improve front-to-rear ratio performance of the antenna subarray 1001.

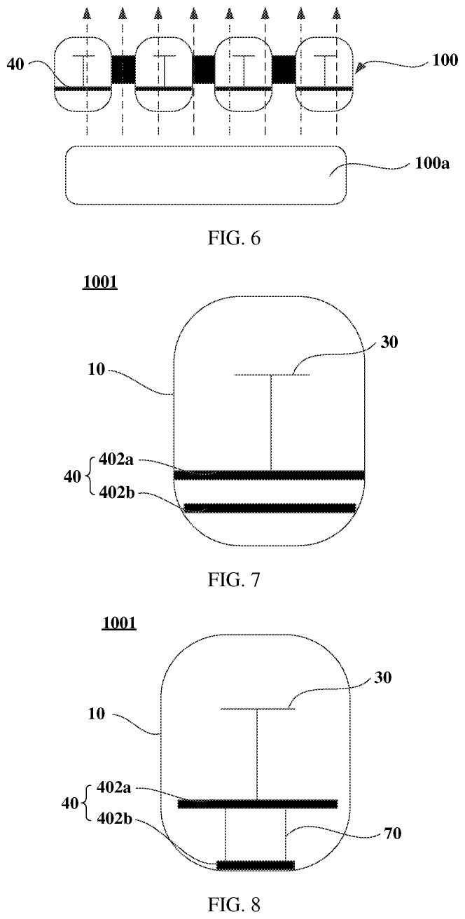

Because a base station usually includes a plurality of antennas 100 operating in different frequency bands, in a general case, the plurality of antennas 100 all need to be mounted on individual mounting surfaces. As a result, a quantity of antennas 100 that can be disposed in the base station is limited. It can be learned from the foregoing description of the reflector 40 of the antenna 100 provided in this application that, when the reflector 40 is a perforated plate-shaped structure, the reflector 40 may be adjusted by adjusting the perforated pattern 401 of the reflector 40, so that the reflector 40 has frequency selectivity, and the reflector 40 can reflect a radio frequency signal of a specific frequency and can transmit a radio frequency signal of a specific frequency. Based on this, in this embodiment of this application, when the perforated pattern 401 of the reflector 40 is specifically set, a wavelength of a radio frequency signal of another operating frequency band may be further considered, so that the antenna 100 provided in this application may be stacked with an antenna of another operating frequency band. For example, FIG. 6 is a diagram of a structure of a stacked arrangement of the antenna 100 and another antenna 100a according to an embodiment of this application. In FIG. 6, the another antenna 100a is disposed behind the antenna 100 provided in this application. Because the reflector 40 of the antenna subarray 1001 of the antenna 100 provided in this application is a perforated plate-shaped structure, and any two adjacent antenna subarrays 1001 are spaced apart from each other, the antenna 100 provided in this application can almost block no radio frequency signal in a specific frequency band range radiated by the another antenna 100a located behind the antenna 100, so that the another antenna 100a located behind the antenna 100 can work normally, thereby implementing co-aperture mounting of antennas in different operating frequency bands. In this way, the antenna can be upgraded and expanded without changing the existing antenna, thereby reducing upgrade costs of the antenna and reducing mounting costs of the antenna.

It should be noted that, in the structure shown in FIG. 6, a specific arrangement of the another antenna 100a is not limited. The another antenna 100a may be a conventional antenna, or may be the antenna provided in this application. In addition, FIG. 6 shows only a case in which two antennas are stacked. In some possible embodiments, three or more antennas may be stacked by designing a perforated pattern of the reflector.

In the foregoing embodiments of this application, an example in which the reflector 40 is a single-layer structure is used for description. In addition, in this application, the reflector 40 may alternatively be of a multi-layer structure. During specific implementation, refer to FIG. 7. FIG. 7 is another sectional view of the antenna subarray 1001 according to this application, and may be used to show another structure of the reflector 40. The reflector 40 shown in FIG. 7 includes at least two sub-reflector layers, the at least two sub-reflector layers are stacked along a side away from the radiating element 30, and any two adjacent sub-reflector layers are spaced apart from each other.

Still refer to FIG. 7. An example in which the reflector 40 includes a sub-reflector layer 402a and a sub-reflector layer 402b is used. The sub-reflector layer 402a and the sub-reflector layer 402b are stacked in a direction away from the radiating element 30, and the adjacent sub-reflector layer 402a and the sub-reflector layer 402b are spaced apart from each other. The reflector 40 uses the foregoing design, and reflection performance of the reflector 40 for reflecting a radio frequency signal radiated by the radiating element 30 may be improved by using a joint design of at least two sub-reflector layers. In addition, by setting the reflector 40 as at least two sub-reflector layers, an overall width of the reflector 40 is further reduced, thereby facilitating a reduction in a width of the antenna subarray 1001. In this way, a spacing between two adjacent antenna subarrays 1001 can be increased without changing an overall size of the antenna 100, or a size of the antenna 100 can be reduced while performance of the antenna 100 is ensured, thereby helping reduce wind resistance of the antenna 100.

In addition, as shown in FIG. 7, each sub-reflector layer of the reflector 40 is connected to the inner sidewall of the radome 10, and a connection manner may be but is not limited to clamping or bonding. Alternatively, in the antenna subarray 1001 shown in FIG. 8, the sub-reflector layer 402b is connected to the inner sidewall of the radome 10, and the sub-reflector layer 402b and the sub-reflector layer 402a that are disposed adjacent to each other are connected via a rigid support member 70. A connection manner between the sub-reflector layer 402a and the sub-reflector layer 402b and the rigid support member 70 may be but is not limited to welding or threaded connection. In the antenna subarray 1001 shown in FIG. 8, the at least one of the sub-reflector layers is connected to the inner sidewall of the radome 10, and two adjacent sub-reflector layers are connected via the rigid support member 70. After the two adjacent sub-reflector layers are connected to the rigid support member 70, the at least one of the sub-reflector layers may be connected to the inner sidewall of the radome 10, thereby effectively improving assembly efficiency of the reflector 40 and the radome 10.

Still refer to FIG. 8. In this application, the sub-reflector layer 402b that is farthest away from the radiating element 30 may be disposed on the inner sidewall of the radome 10. The sub-reflector layer 402b may be disposed on the radome 10 in a manner of coating, pasting, or threaded connection, but is not limited thereto. In this way, a connection manner between the reflector 40 and the radome 10 can be effectively simplified.

It should be noted that, when the reflector 40 of the antenna subarray 1001 is disposed in a manner of using a plurality of sub-reflector layers, each sub-reflector layer may be of a continuous plate-shaped structure, to ensure performance of the reflector 40 of the antenna subarray 1001 in reflecting a radio frequency signal radiated by the radiating element 30. In addition, each sub-reflector layer may be further set to a perforated plate-shaped structure, so that through joint design of perforated patterns of a plurality of sub-reflector layers, radio frequency signals of other specific frequency bands may be radiated through the reflector 40 while radiation performance of the antenna subarray 1001 is ensured, thereby providing a possibility for stacking a plurality of antennas of different operating frequency bands.

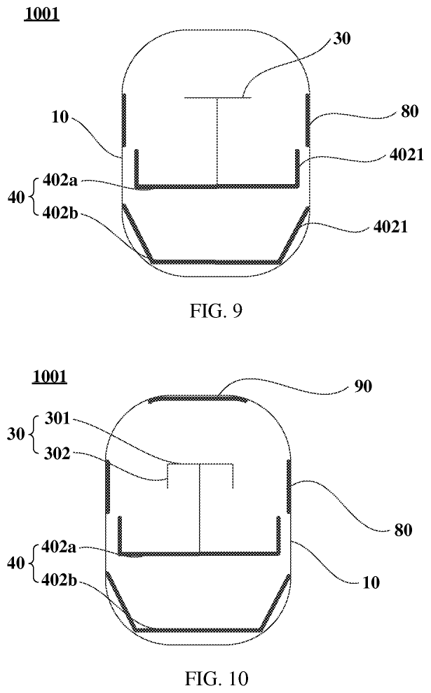

FIG. 9 is another sectional view of the antenna subarray 1001 according to this application. At least one of the sub-reflector layers of the reflector 40 of the antenna subarray 1001 includes two bent portions 4021 disposed opposite to each other, and each bent portion 4021 is bent in a direction from the reflector 40 toward the radiating element 30. In this way, performance of the reflector 40 in reflecting a radio frequency signal radiated by the radiating element 30 can be effectively improved, and an overall width of the reflector 40 can be reduced, thereby helping reduce a width of the antenna subarray 1001. It should be noted that, in this application, a width direction of the reflector 40 is perpendicular to an axial direction of the radome 10.

A bending angle of the bent portion 4021 of the sub-reflector layer is not limited in this application. For example, an included angle between each bent portion 4021 and a portion of the sub-reflector layer located between two bent portions 4021 is greater than or equal to 90°. For example, in the antenna subarray 1001 shown in FIG. 9, an included angle between two bent portions 4021 of one sub-reflector layer 402a of the reflector 40 and a portion of the sub-reflector layer 402a located between the two bent portions 4021 is 90°, and an included angle between two bent portions 4021 of another sub-reflector layer 402b of the reflector 40 and a portion of the sub-reflector layer 402b located between the two bent portions 4021 is greater than 90°. The foregoing is merely an example description of some specific arrangements of the bent portion 4021 of the sub-reflector layer. Based on this, some adaptive variations may be further made to disposing of the bent portion 4021 of each sub-reflector layer. For example, bending angles of the two bent portions 4021 of each sub-reflector layer may be different. This should be understood as falling within the protection scope of this application.

Still refer to FIG. 9. Each antenna subarray 1001 may further include two metal baffle plates 80. The two metal baffle plates 80 are disposed opposite to each other, and the two metal baffle plates 80 are connected to the inner sidewall of the radome 10. A material of the two metal baffle plates 80 may be, but is not limited to, copper or aluminum. In addition, each metal baffle plate 80 may be connected to the inner sidewall of the radome 10 in a manner of bonding or threaded connection, or the metal baffle plate 80 is a metal coating coated on the inner sidewall of the radome 10.

It may be understood that, the two metal baffle plates 80 of each antenna subarray 1001 are respectively located at two end portions of the reflector 40 facing the adjacent antenna subarray 1001. Therefore, in each antenna subarray 1001, an arrangement direction of the two metal baffle plates 80 is the same as an arrangement direction of two bent portions 4021 of each sub-reflector layer. In addition, as shown in FIG. 10, the radiating element 30 may be located between two metal baffle plates 80. In this way, the two metal baffle plates 80 may reflect a radio frequency signal radiated by the radiating element 30, which helps improve front-to-rear ratio performance of the antenna subarray 1001, and therefore improves signal radiation performance of the antenna subarray 1001.

FIG. 10 is another sectional view of the antenna subarray 1001 according to this application. In comparison with the antenna subarray 1001 shown in FIG. 9, in FIG. 10, the radiating element 30 of the antenna subarray 1001 includes a first radiating portion 301 and a second radiating portion 302 that are connected to each other. The first radiating portion 301 and the second radiating portion 302 form a predetermined included angle, the first radiating portion 301 is connected to the reflector 40, and the second radiating portion 302 is bent in a direction from the first radiating portion 301 toward the reflector 40. In this application, the radiating element 30 of the antenna subarray 1001 is designed in the foregoing two bending manners, so that an area occupied by the radiating element 30 on the reflector 40 can be effectively reduced. This helps reduce a size of the reflector 40, and further helps reduce a width size of the antenna subarray 1001. In this way, a spacing between two adjacent antenna subarrays 1001 can be increased without changing an overall size of the antenna 100, or a size of the antenna 100 can be reduced while performance of the antenna 100 is ensured, thereby helping reduce wind resistance of the antenna 100.

An included angle between the first radiating portion 301 and the second radiating portion 302 is not limited in this application. For example, in the antenna subarray 1001 shown in FIG. 10, the included angle between the first radiating portion 301 and the second radiating portion 302 is 90°, that is, the first radiating portion 301 and the second radiating portion 302 are disposed perpendicularly. In another possible embodiment, the first radiating portion 301 and the second radiating portion 302 may alternatively be disposed at another angle. Details are not listed herein.

Still refer to FIG. 10. The antenna subarray 1001 further includes a band-stop reactance layer 90, and the band-stop reactance layer 90 is connected to the inner sidewall of the radome 10. A connection manner of the band-stop reactance layer 90 may be but is not limited to bonding, threaded connection, or the like. Alternatively, the band-stop reactance layer 90 is a metal coating coated on the inner sidewall of the radome 10.

As shown in FIG. 10, the radiating element 30 is located between the band-stop reactance layer 90 and the reflector 40. In addition, the band-stop reactance layer 90 is a metal hollow layer, and a radio frequency signal radiated by the radiating element 30 may be radiated through a perforated portion of the band-stop reactance layer 90. In this way, a perforated pattern of the band-stop reactance layer 90 may be appropriately designed, to adjust a bandwidth of the radio frequency signal radiated by the radiating element 30, thereby improving signal radiation performance of the antenna subarray 1001.

In this embodiment of this application, as shown in FIG. 10, a projection of the band-stop reactance layer 90 onto the reflector 40 covers a projection of the radiating element 30 onto the reflector 40. In this way, effect of adjusting, by the band-stop reactance layer 90, a bandwidth of a radio frequency signal radiated by the radiating element 30 can be improved, thereby improving electrical performance of the antenna subarray 1001.

It should be noted that, in both FIG. 9 and FIG. 10, the antenna subarray 1001 of the reflector 40 including at least two sub-reflector layers is described. When the reflector 40 of the antenna subarray 1001 is a single-layer structure, each structure of the antenna subarray 1001 may also be disposed with reference to the antenna subarray 1001 shown in FIG. 9 and FIG. 10. For example, the bent portion 4021 may also be disposed on the reflector 40 of the single-layer structure, the radiating element 30 may also be designed in a two-portion bending manner, and the two metal baffle plates 80 and the band-stop reactance layer 90 may also be disposed on the antenna subarray 1001. Specific arrangements are not described herein again.

In the foregoing descriptions of the antenna 100 in embodiments of this application, one antenna subarray 1001 is used as an example to describe a structure of the antenna subarray 1001 of the antenna 100. It may be understood that, the antenna subarrays 1001 of the antenna 100 may be disposed in a same manner or different manners. For example, FIG. 11 is a diagram of another structure of the antenna 100 according to an embodiment of this application. FIG. 11 is used to show a manner of disposing the radiating element 30 in the antenna 100 on the reflector 40. Each antenna subarray 1001 includes at least two radiating elements 30, and the at least two radiating elements 30 may be disposed in an array on the reflector 40. Specifically, in at least one antenna subarray 1001, the at least two radiating elements 30 may be sequentially arranged in an axial direction of the radome 10, that is, the at least two radiating elements 30 are arranged into one radiating element array. However, in another antenna subarray 1001, the at least two radiating elements 30 may be further divided into two or more radiating element arrays that are arranged in the axial direction of the radome 10.

It may be understood that the foregoing embodiment is merely some examples for describing a specific arrangement of the antenna 100 provided in this application. Based on this, some adaptive variations may be further performed on the antenna subarray 1001, or various structures in the antenna subarray 1001 described in different embodiments may be appropriately combined. Various possible structures of the antenna subarray 1001 provided in this application are not described herein one by one, but all of the structures should be understood as falling within the protection scope of this application.

It can be learned from the foregoing description that the at least two antenna subarrays 1001 of the antenna 100 are connected to each other through the mounting structural member 1002. In the foregoing embodiment, for example, in the antenna 100 shown in FIG. 3 or FIG. 4, the mounting structural member 1002 may be of a beam structure, and the antenna 100 may include at least two mounting structural members 1002, and the at least two mounting structural members 1002 may be spaced in the axial direction of the radome 10 of each antenna subarray 1001. In addition, at least one of the radome 10 or the reflector 40 of each antenna subarray 1001 is connected to each mounting structural member 1002, so that at least two antenna subarrays 1001 are reliably connected, which helps improve structural reliability of the antenna 100.

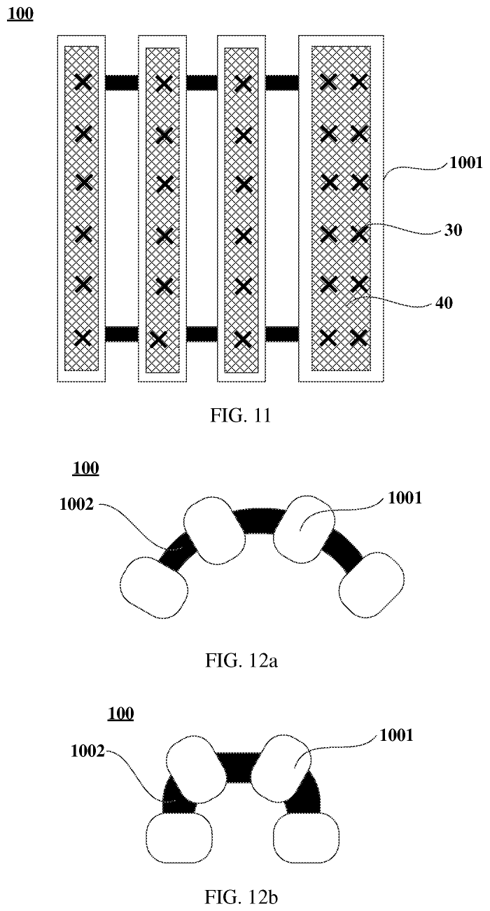

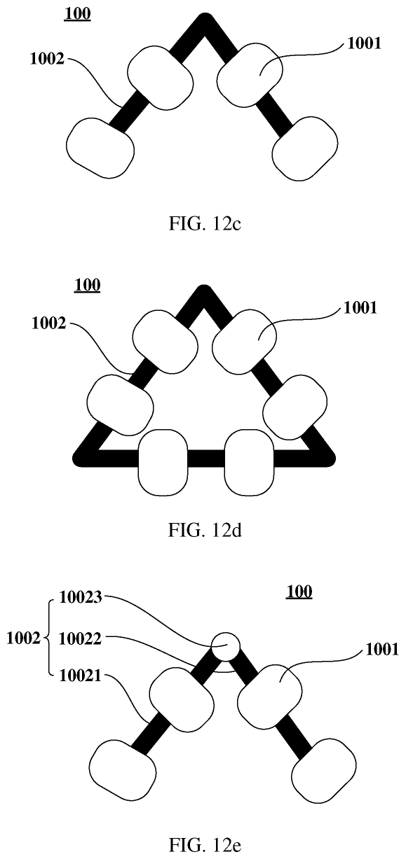

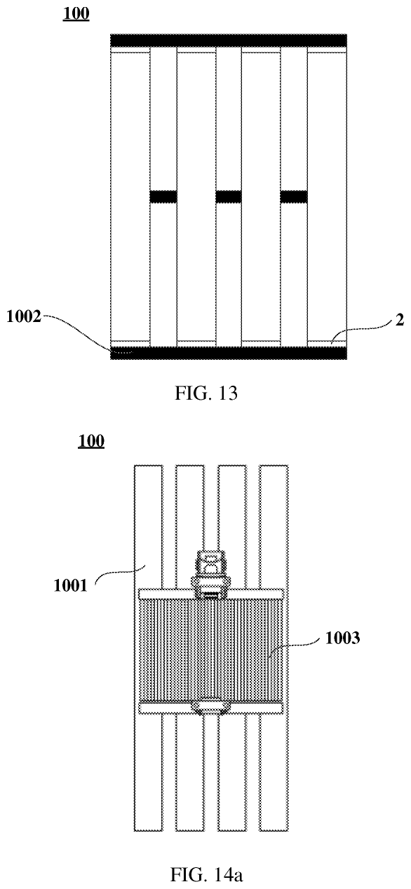

In this embodiment of this application, in addition to the foregoing arrangement, the mounting structural member 1002 of the antenna 100 may alternatively be disposed in another possible manner. For example, FIG. 12a is a diagram of another structure the antenna 100 according to an embodiment of this application. FIG. 12a is used to show an arrangement of the mounting structural member 1002 of the antenna 100. In the antenna 100 shown in FIG. 12a, the mounting structural member 1002 is a bent structure. The antenna 100 also includes at least two mounting structural members 1002, and the at least two mounting structural members 1002 are spaced apart from each other. For example, the at least two mounting structural members 1002 may be spaced in the axial direction of the radome 10 of each antenna subarray 1001. In addition, at least one of the radome 10 or the reflector 40 of each antenna subarray 1001 is connected to each mounting structural member 1002, so that the at least two antenna subarrays 1001 are reliably connected, which helps improve structural reliability of the antenna 100.

In the antenna 100 shown in FIG. 12a, a bending shape of the mounting structural member 1002 is an arc shape. In addition, the mounting structural member 1002 may be bent into another possible shape. For example, in the antenna 100 shown in FIG. 12 b, a bending shape of the mounting structural member 1002 is a U shape. For another example, in the antenna 100 shown in FIG. 12c, the bending shape of the mounting structural member 1002 is a V shape. For another example, in the antenna 100 shown in FIG. 12d, the bending shape of the mounting structural member 1002 is a triangle.

A form of the mounting structural member 1002 of the antenna 100 described in the foregoing embodiment is a fixed form. In some possible embodiments of this application, a form of the mounting structural member 1002 may be further adjustable. For example, in the antenna 100 shown in FIG. 12e, the mounting structural member 1002 includes a first rotating portion 10021 and a second rotating portion 10022, and the first rotating portion 10021 and the second rotating portion 10022 are hinged through a hinge shaft 10023, so that an included angle between the first rotating portion 10021 and the second rotating portion 10022 can be adjusted. In addition, at least one of the radome 10 or the reflector 40 of at least one of the at least two antenna subarrays 1001 is connected to the first rotating portion 10021, and at least one of the radome 10 or the reflector 40 of at least one of the at least two antenna subarrays 1001 is connected to the second rotating portion 10022. In the antenna 100 shown in FIG. 12e, an overall form of the antenna 100 may be adjusted by rotating the first rotating portion 10021 and the second rotating portion 10022 relative to each other, so that the antenna 100 can meet requirements of different application scenarios for the form of the antenna 100. This helps expand an application scope of the antenna 100.

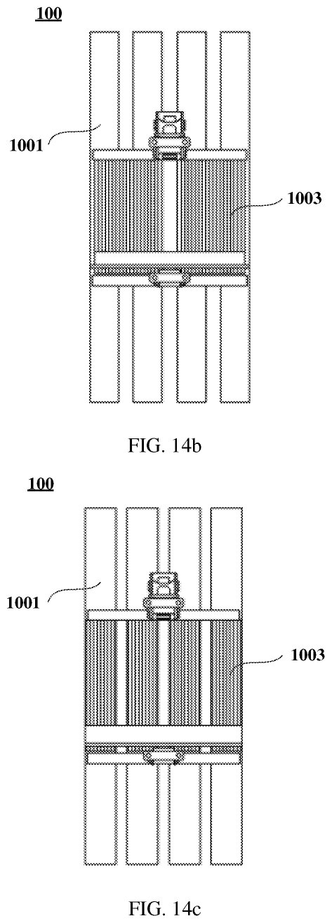

In the foregoing embodiment of this application, the mounting structural member 1002 may be of an independent mechanical part. In this case, the mounting structural member 1002 may be connected to each antenna subarray 1001 by connecting to the radome body 1 of the radome 10 of each antenna subarray 1001 or the reflector 40. However, in some possible embodiments, the mounting structural member 1002 may be further integrated with some structures of the antenna subarray 1001. For example, in the antenna 100 shown in FIG. 13, the mounting structural member 1002 may be integrally formed with the end covers 2 disposed on a same side of at least two antenna subarrays 1001. This helps simplify a structure of the antenna 100 and improve assembly efficiency of the antenna 100.

It should be noted that, in the antenna 100 shown in FIG. 13, there are at least two mounting structural members 1002. One mounting structural member 1002 is integrated with the end covers 2 disposed on a same side of the at least two antenna subarrays 1001, and the other mounting structural member is integrated with the end covers 2 disposed on the other side of the at least two antenna subarrays 1001, to further improve assembly efficiency of the antenna 100.

The foregoing embodiment is merely some examples of descriptions of a specific manner of disposing the mounting structural member 1002. Based on this, some adaptive variations may be further made to the manner of disposing the mounting structural member 1002. Various possible manners of disposing the mounting structural member 1002 are not described one by one herein, but all should be understood as falling within the protection scope of this application.

In addition to the foregoing structure, the antenna 100 provided in this embodiment of this application may further include a radio frequency active module 1003. During specific implementation, refer to FIG. 14a. FIG. 14a is a diagram of another structure of the antenna 100 according to an embodiment of this application. In the antenna 100, the radio frequency active module 1003 is located outside each antenna subarray 1001, and the radio frequency active module 1003 is connected to at least one of the radome 10 or the reflector 40 of each antenna subarray 1001. A connection manner may be, but is not limited to, a buckle connection, welding, riveting, or threaded connection. In addition, the radio frequency active module 1003 is electrically connected to the radiating element 30 of each antenna subarray 1001. The radio frequency active module 1003 may be electrically connected to each radiating element 30 in a plug-in manner. This helps improve convenience of electrical connection between the radio frequency active module 1003 and each radiating element 30, and can reduce a connection cable between the radio frequency active module 1003 and the radiating element 30, thereby helping reduce costs of the antenna 100.

FIG. 14b is a diagram of another structure of the antenna 100 according to an embodiment of this application. Different from the antenna 100 shown in FIG. 14a, the antenna 100 shown in FIG. 14b includes at least two radio frequency active modules 1003, where the at least two radio frequency active modules 1003 are located outside each antenna subarray 1001, each radio frequency active module 1003 is connected to at least one of the radome 10 of the at least one antenna subarray 1001 or the reflector 40, and each radio frequency active module 1003 is electrically connected to the radiating element 30 of the at least one antenna subarray 1001. During specific implementation, as shown in FIG. 14b, the antenna 100 includes two radio frequency active modules 1003 and four antenna subarrays 1001. In this case, the two radio frequency active modules 1003 may be connected to form an integral portion, and then connected to at least one of the radome 10 of the four antenna subarrays 1001 or the reflector 40. In addition, each radio frequency active module 1003 is electrically connected to the radiating element 30 of the two antenna subarrays 1001. The antenna 100 provided in this application uses the design manner shown in FIG. 14b, so that flexibility of disposing the radio frequency active module 1003 and flexibility of connecting the radio frequency active module 1003 to the radiating elements 30 of the at least two antenna subarrays 1001 can be effectively improved.

In addition, to further improve flexibility of disposing the radio frequency active module 1003, refer to FIG. 14c. FIG. 14c is a diagram of another structure of the antenna 100 according to an embodiment of this application. The antenna 100 shown in FIG. 14c includes at least two radio frequency active modules 1003, and the at least two radio frequency active modules 1003 are disposed in a one-to-one correspondence with at least two antenna subarrays 1001. To be specific, each radio frequency active module 1003 is located outside the radome 10 of a corresponding antenna subarray 1001, and each radio frequency active module 1003 is electrically connected to the radiating element 30 of a corresponding antenna subarray 1001. With such a design, flexibility of an overall form design of the antenna 100 can be further effectively improved, so that the antenna 100 is applicable to a wider scenario range.

It may be understood that, regardless of which of the foregoing manners is used for disposing the radio frequency active module 1003 of the antenna 100, the radio frequency active module 1003 may be appropriately designed based on a specific requirement, so that each antenna subarray 1001 can work independently, and the antenna subarrays 1001 do not affect each other; or each antenna subarray 1001 can be used together.

It should be noted that the foregoing embodiment is merely some examples of descriptions of a specific arrangement of the antenna 100 provided in this application. Based on this, some adaptive variations may be further made to the antenna 100, or various structures of the antennas described in different embodiments may be appropriately combined. For example, in a possible embodiment of this application, the antenna 100 also includes at least two antenna subarrays 1001 and the mounting structural member 1002. Each antenna subarray 1001 includes the radome 10, the reflector 40, and the radiating element 30. The radiating element 30 is located on a side of the reflector 40, and the radiating element 30 is connected to the reflector 40. The reflector 40 and the radiating element 30 are accommodated in the radome 10. The radome 10 includes the radome body 1 and the two end covers 2. The two end covers 2 are respectively disposed at two end portions of the radome body 1, and each end cover 2 seals one end portion of the radome body 1. In this embodiment, the radome body 1 of the radome 10 of the antenna subarray 1001 is not of an integral structure. In other words, the radome body 1 of the radome 10 is an assembled structure. In this case, the reflector 40 of the antenna subarray 1001 may also be disposed as a perforated plate-shaped structure. For other structures of the antenna subarray 1001, refer to any one of the foregoing embodiments. Details are not described herein again. In addition, various possible arrangements of the antenna 100 provided in this application are not described herein one by one, but should be understood as falling within the protection scope of this application.

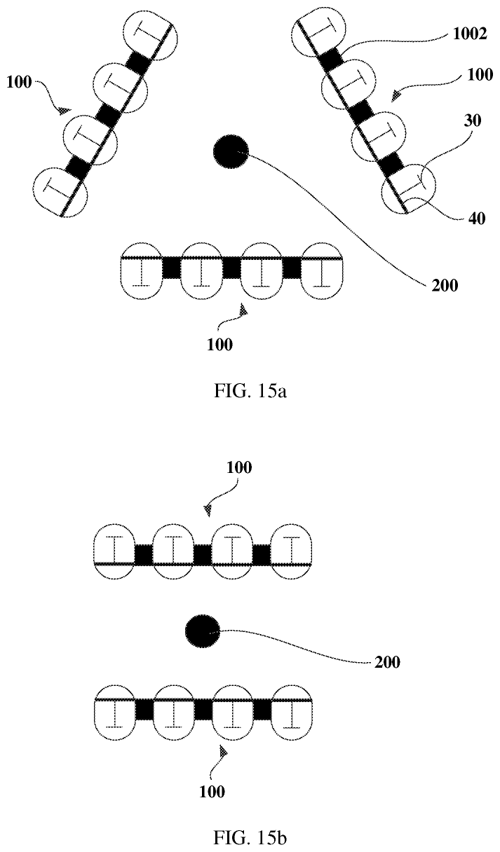

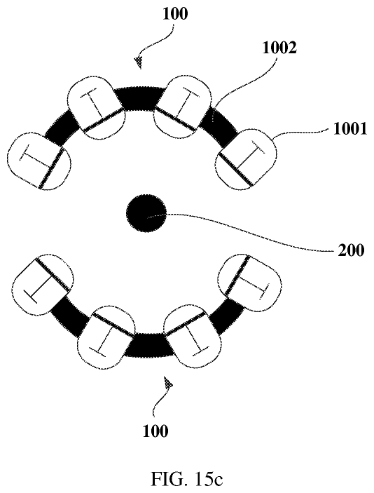

When the antenna 100 provided in any one of the foregoing embodiments of this application is used in the base station 1000 shown in FIG. 2, a form, a quantity, and the like of the antenna 100 may be selected based on a specific application scenario. For example, FIG. 15a is a diagram of a connection structure between the antenna 100 and the support 200 in the base station 1000 shown in FIG. 2. The base station 1000 may include the support 200 and three antennas 100. The support 200 may be, but is not limited to, a pole or a tower. Mounting structural members 1002 of the three antennas 100 are of all beam structures, that is, the antennas 100 are designed in a flat plate shape. The three antennas 100 are all connected to the support 200, and the three antennas 100 are disposed at an equal spacing around the support 200. In addition, the radiating element 30 of each antenna 100 is located on a side of the reflector 40 away from the support 200. In this way, three-sector signal coverage of the base station 1000 can be implemented, that is, 360° full coverage of a signal radiated by the antenna 100 can be implemented.

In addition, FIG. 15b is a diagram of another connection structure between the antenna 100 and the support 200 in the base station shown in FIG. 2. The base station 1000 includes only two antennas 100 designed in a flat plate shape, to implement two-sector signal coverage of the base station 1000. A specific arrangement of the base station 1000 is similar to that of the base station 1000 shown in FIG. 15a, and details are not described herein again.

For another example, in a connection structure between the antenna 100 and the support 200 shown in FIG. 15c, if the mounting structural member 1002 of the antenna 100 is an arc-shaped bent structure, at least two antenna arrays 1001 of the antenna 100 may be arranged along an arc. In this case, two antennas 100 may be used in the base station 1000 to implement 360° full coverage of a radiated signal.

The foregoing embodiment is merely some examples of specific arrangements of the antenna 100 provided in this embodiment of this application in the base station 1000. Based on this, a quantity, a form, and the like of the antenna 100 may be adaptively changed based on different application scenarios. Details are not described herein, but should be understood as falling within the protection scope of this application.

In this embodiment of this application, still refer to FIG. 2. The base station 1000 may further include the baseband processing unit 300, and the baseband processing unit 300 may be connected to the antenna 100 through the radio frequency active module 1003. In some embodiments, the radio frequency active module 1003 may also be referred to as a remote radio unit (remote radio unit, RRU), and the baseband processing unit 300 may also be referred to as a baseband unit (baseband unit, BBU).

As shown in FIG. 2, in this embodiment of this application, the radio frequency active module 1003 may be disposed together with the antenna 100. However, the baseband processing unit 300 is located at a remote end of the antenna 100. In some other embodiments, the radio frequency active module 1003 and the baseband processing unit 300 may alternatively be both located at the remote end of the antenna 100. The radio frequency active module 1003 may be connected to the baseband processing unit 300 through a connection wire 400.

In addition, as shown in FIG. 2, a grounding apparatus 500 may be further disposed between the baseband processing unit 300 and the connection wire 400. The grounding apparatus 500 generally includes a grounding electrode buried underground. A sealing member may be disposed at a joint between the antenna 100 and the connection wire 400, and a sealing member may also be disposed at a joint between the grounding apparatus 500 and the connection wire 400. The sealing member may specifically include at least one of an insulation sealing tape and a polyvinyl chloride (polyvinyl chloride, PVC) insulation tape. Certainly, the sealing member may alternatively be another structure, and is not limited to a tape form.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An antenna, comprising at least two antenna subarrays and a mounting structural member, wherein each antenna subarray comprises a radome, a reflector, and a radiating element, the radiating element is located on a side of the reflector and connected to the reflector, and the reflector and the radiating element are accommodated in the radome;
the radome comprises a radome body and two end covers, the radome body is an integral structure, the two end covers are respectively disposed at two end portions of the radome body, each end cover seals one end portion of the radome body, and the reflector is connected to an inner sidewall of the radome; and
the mounting structural member is located outside the radome of each antenna subarray, and at least one of the radome or the reflector of each antenna subarray is connected to the mounting structural member, and any two adjacent antenna subarrays are spaced apart from each other.

2. The antenna according to claim 1, wherein the reflector is a continuous plate-shaped structure, or the reflector is a perforated plate-shaped structure.

3. The antenna according to claim 1, wherein the reflector comprises at least two sub-reflector layers, the at least two sub-reflector layers are stacked along a side away from the radiating element, and any two adjacent sub-reflector layers are spaced apart from each other.

4. The antenna according to claim 3, wherein each sub-reflector layer is connected to the inner sidewall of the radome, or at least one of the sub-reflector layers is connected to the inner sidewall of the radome, and two adjacent sub-reflector layers are connected via a rigid support member.

5. The antenna according to claim 3, wherein the at least one of the sub-reflector layers comprises two oppositely disposed bent portions, and each bent portion is bent in a direction from the reflector toward the radiating element.

6. The antenna according to claim 1, wherein the radiating element comprises a first radiating portion and a second radiating portion that are connected, the first radiating portion and the second radiating portion form a predetermined included angle, the first radiating portion is connected to the reflector, and the second radiating portion is bent in a direction from the first radiating portion toward the reflector.

7. The antenna according to claim 6, wherein each antenna subarray further comprises a band-stop reactance layer, the band-stop reactance layer is a perforated metal layer, the radiating element is located between the band-stop reactance layer and the reflector, and the band-stop reactance layer is connected to the inner sidewall of the radome.

8. The antenna according to claim 7, wherein a projection of the band-stop reactance layer onto the reflector covers a projection of the radiating element onto the reflector.

9. The antenna according to claim 1, wherein a cross-sectional shape of the radome body of the radome is elliptical, circular, or rounded-rectangular.

10. The antenna according to claim 1, wherein the mounting structural member is a bent structure, the antenna comprises at least two mounting structural members, the two mounting structural members are spaced apart from each other, and at least one of the radome or the reflector of each antenna subarray is connected to each mounting structural member.

11. The antenna according to claim 1, wherein the mounting structural member comprises a first rotating portion and a second rotating portion, the first rotating portion is hinged to the second rotating portion, at least one of the radome or the reflector of at least one of the at least two antenna subarrays is connected to the first rotating portion, and at least one of the radome or the reflector of at least one of the at least two antenna subarrays is connected to the second rotating portion.

12. The antenna according to claim 1, wherein the antenna further comprises a radio frequency active module, the radio frequency active module is located outside the radome of each antenna subarray, the radio frequency active module is connected to at least one of the radome or the reflector of each antenna subarray, and the radio frequency active module is electrically connected to the radiating element of each antenna subarray.

13. The antenna according to claim 1, wherein the antenna further comprises at least two radio frequency active modules, the at least two radio frequency active modules are located outside the radome of each antenna subarray, each radio frequency active module is connected to at least one of the radome or the reflector of at least one antenna subarray, and each radio frequency active module is electrically connected to the radiating element of at least one antenna subarray.

14. The antenna according to claim 13, wherein the at least two radio frequency active modules are disposed in a one-to-one correspondence with the at least two antenna subarrays, each radio frequency active module is located outside the radome of a corresponding antenna subarray, and each radio frequency active module is electrically connected to the radiating element of a corresponding antenna subarray.

15. A base station, comprising a support and an antenna connected to the support,
wherein the antenna comprises at least two antenna subarrays and a mounting structural member, wherein each antenna subarray comprises a radome, a reflector, and a radiating element, the radiating element is located on a side of the reflector and connected to the reflector, and the reflector and the radiating element are accommodated in the radome;
the radome comprises a radome body and two end covers, the radome body is an integral structure, the two end covers are respectively disposed at two end portions of the radome body, each end cover seals one end portion of the radome body, and the reflector is connected to an inner sidewall of the radome; and
the mounting structural member is located outside the radome of each antenna subarray, and at least one of the radome or the reflector of each antenna subarray is connected to the mounting structural member, and any two adjacent antenna subarrays are spaced apart from each other.

16. The base station according to claim 15, wherein the reflector is a continuous plate-shaped structure, or the reflector is a perforated plate-shaped structure.

17. The base station according to claim 15, wherein the reflector comprises at least two sub-reflector layers, the at least two sub-reflector layers are stacked along a side away from the radiating element, and any two adjacent sub-reflector layers are spaced apart from each other.

18. The base station according to claim 15, wherein the radiating element comprises a first radiating portion and a second radiating portion that are connected, the first radiating portion and the second radiating portion form a predetermined included angle, the first radiating portion is connected to the reflector, and the second radiating portion is bent in a direction from the first radiating portion toward the reflector.

19. The base station according to claim 15, wherein the mounting structural member is a bent structure, the antenna comprises at least two mounting structural members, the two mounting structural members are spaced apart from each other, and at least one of the radome or the reflector of each antenna subarray is connected to each mounting structural member.

20. The base station according to claim 15, wherein the mounting structural member comprises a first rotating portion and a second rotating portion, the first rotating portion is hinged to the second rotating portion, at least one of the radome or the reflector of at least one of the at least two antenna subarrays is connected to the first rotating portion, and at least one of the radome or the reflector of at least one of the at least two antenna subarrays is connected to the second rotating portion.
